(19) United States
(12) Patent Application Publication
(10) Pub. No.: US 2012/0088023 A1
(43) Pub. Date: Apr. 12, 2012

(54) METHOD FOR MOLDING CHOCOLATE FROM THREE DIMENSIONAL IMAGES

(75) Inventor: Brian BEGUN, Canoga Park, CA (US)

(73) Assignee: BMFD HOLDINGS, LLC, Canoga Park, CA (US)

(21) Appl. No.: 13/269,337

(22) Filed: Oct. 7, 2011

Related U.S. Application Data
(60) Provisional application No. 61/391,563, filed on Oct. 8, 2010.

(51) Int. Cl. A23G 1/22

(52) U.S. Cl. 426/515

(57) ABSTRACT

A method is disclosed for molding chocolate, candy or other food materials into a molded, edible product in a shape based upon one or more three dimensional images of an original object that is desired to be replicated. Three dimensional molds are formed based upon three dimensional image data obtained by three dimensional scanning or processing of two dimensional images, and three dimensional printing of mold forms. The method of the invention minimizes distortion and loss of detail in the final molded product, utilizing food safe/FDA compliant materials in the construction of molds.

### CROSS-REFERENCES TO RELATED APPLICATIONS

This application is based upon and claims priority from U.S. Provisional Application No. 61/391,563, filed Oct. 8, 2010, which is incorporated by reference in its entirety.

### BACKGROUND OF THE INVENTION

The present invention relates generally to methods for molding chocolate or other edible materials that can be cast into a desirable shape, and more particularly relates to methods for molding chocolate, candy or other food materials into a molded, edible product in a desirable shape derived from three dimensional images.

Various conventional methods have been used to cast and mold chocolate. One such known method for molding chocolate involves molding chocolate blocks having a relief pattern of one color and a body portion of a different color, by casting a first chocolate material into a first mold, and placing a second mold on the first mold and casting a second chocolate material through openings of the second mold for forming the body portion. Another known method for molding chocolate involves forming a mold assembly from sheet-like mold halves held together by magnets, and base flanges that support the mold assembly in an upright position for filling through an edge fill opening. Another known method for producing a molded chocolate product with an exterior decorative pattern involves charging a low viscosity fluidized chocolate material into an elastic mold in bag form to allow air bubbles to be removed, charging tempered fluidized chocolate material into the elastic mold, and solidifying the chocolate materials. Another known method for molding chocolate tablets and pieces involves rotating a chilled mold while liquid chocolate cools and partially sets while in contact with the rotating mold.

The vacuum forming or thermoforming method is currently the industry standard for forming a mold for molding chocolate into a desired shape. Typically, a sheet of thermoplastic material is heated until the material becomes pliable, and then the heated material is stretched over a mold or formed in a mold created from a prototype or original object desired to be copied using a vacuum. A common problem of current methods for molding chocolate is that they typically require an original object to be copied and molded to be placed in direct contact with heated plastic to form a master mold. When this method is used for molding chocolate, the resulting chocolate copies of original objects typically distort or lose detail of an original counterpart, often due to degradation of the original object to be molded during the process of vacuum forming or thermoforming itself, so that severe limitations are placed upon the quality of copies that can be expected from original three dimensional objects desired to be molded. Furthermore, while other methods can be used to form molds, such molds typically are not formed with food safe/FDA compliant materials that would be safe for use in forming chocolate, candy or other food materials into a molded, edible product.

It would be desirable to provide a method for molding chocolate, candy or other food materials into a molded, edible product in a desirable shape derivable from three dimensional images in order to substantially improve the quality of replications molded in chocolate, candy, or other food materials suitable for casting in a mold, by avoiding physical contact with and physical and/or thermal degradation of an original object that is desired to be replicated, and that minimizes distortion and loss of detail in the final molded product. It would also be desirable to provide a method for molding chocolate, candy or other food materials into a molded, edible product in a desirable three dimensional shape that would allow users and customers more flexibility and an increased ability to customize design and production of molded chocolate, candy or other food materials. The present invention meets these and other needs.

### SUMMARY OF THE INVENTION

Briefly and in general terms, the present invention provides for a method for molding chocolate, candy or other food materials into a molded, edible product in a shape based upon one or more three dimensional images of an original object that is desired to be replicated. The method of the invention substantially increases the achievable quality of replications of an original object molded in chocolate, candy, or other food materials that are suitable for casting in a mold, in a manner that avoids physical contact with and physical and/or thermal degradation of the original object. The method of the invention minimizes distortion and loss of detail in the final molded product, utilizing food safe/FDA compliant materials in the construction of molds.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIGS. 1-9 together form a flow chart of the steps of the method of the invention.

### DETAILED DESCRIPTION OF THE PREFERRED EMBODIMENTS

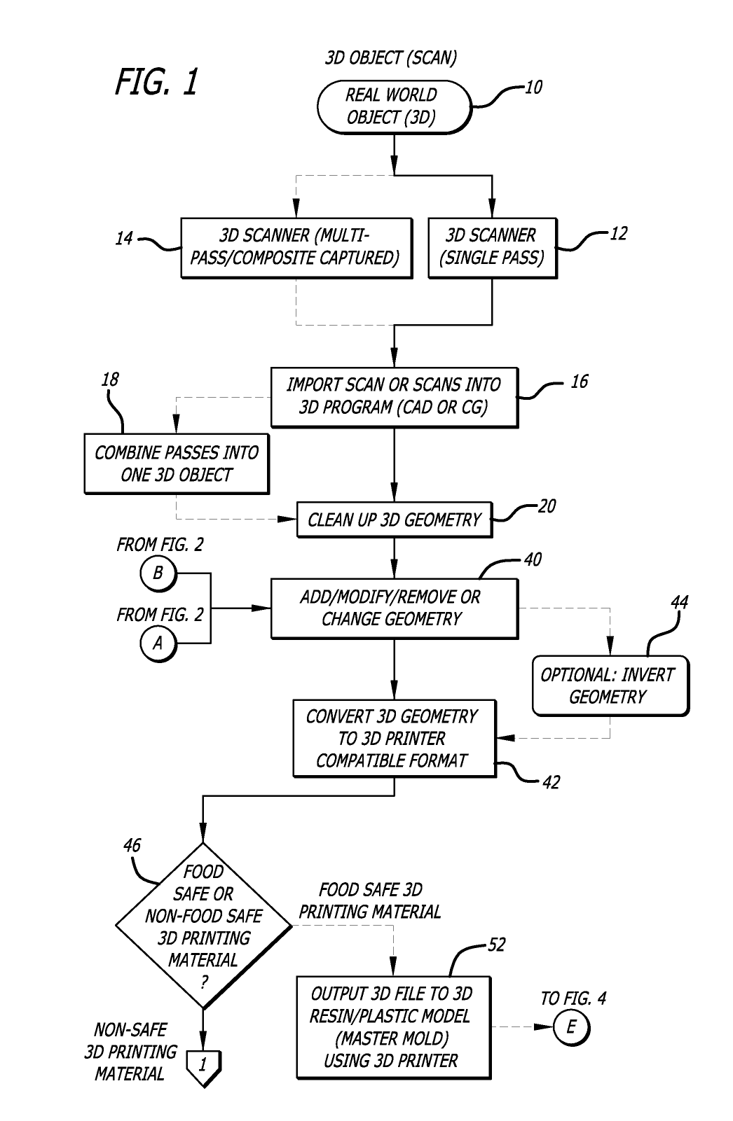

Referring to the drawings, which are provided by way of example, and not by way of limitation, the present invention provides for a method for producing molded three dimensional shapes from chocolate, candy, or other food materials that are suitable for casting in a mold from a real world three dimensional (3D) object 10, herein defined as any object/item that has three dimensions, as is illustrated in FIG. 1. Typically, the size of the real world 3D object should be no bigger that a car or truck, but just about any size object can be used, particularly if the object can be molded and constructed in sections. A single pass 3D scanner 12 is preferably used, although a suitable multi-pass or composite capture 3D scanner 14 may also be used, in order to optically image and provide 3D data points of a real-world object describing the shape, and optionally also color, which are typically taken along and stored in x, y, and z axes. Although both the single pass and multi-pass scanners use a triangulation method to determine the coordinates of a scanned object, single pass 3D scanners are typically portable, and use an internal coordinate system to determine where the scanner is in relationship to the object. Multi-pass 3D scanners typically do not utilize an internal coordinate system, and instead rely on capturing data from a fixed position, while the object rotates around the multi-pass scanner on a motorized platform, or is repositioned so that the multi-pass scanner can take snapshots that are then combined together in a composite.

Such 3D scanners are typically either contact scanners, which probe an object by physically touching the object, or non-contact type scanners, which can be passive, which typically detect ambient light or other radiation reflected from an object, or active scanners, which typically emit light, such as a laser beam, or ultrasound, x-ray or other radiation, and detect a reflection of the emitted light or radiation from an object. Non-contact based scanners are preferred for the purpose of the present invention. If the object to be scanned is highly reflective (i.e. metal) or transparent (i.e. a window), a dulling material such as talcum powder also can be placed over the surface of the object to avoid undesirable glare and allow the scanner to collect 3D data properly.

The 3D scanner generates a scan file, typically in the .STL file format, including the 3D data points of the real-world object from the one or more scans of the object, which is imported in step 16 into a computer for use in a 3D computer program, such as a CAD or CG program. The STL file format is typically used to describe only the surface geometry of a three dimensional object without any representation of color, texture or other common CAD model attributes, typically in either ASCII or binary, although some variations of the standard STL format support color. For the purposes of modification of the originally scanned data, this file can be imported into a CAD or CG program, and may be converted to another file format. If a multi-pass 3D scanner is used, multiple parts of the scanned object will be created, and will need to be combined or “stitched” together at step 18, typically using a 3D computer program. In step 20, after the object is scanned (and optionally assembled), depending upon the quality of the scan data, the data for the object can be edited to remove any errors or noise in the scan that could cause inaccurate data points. Using a 3D computer program, the data cleanup is done simply by removing, deleting or manually repositioning any offending points.

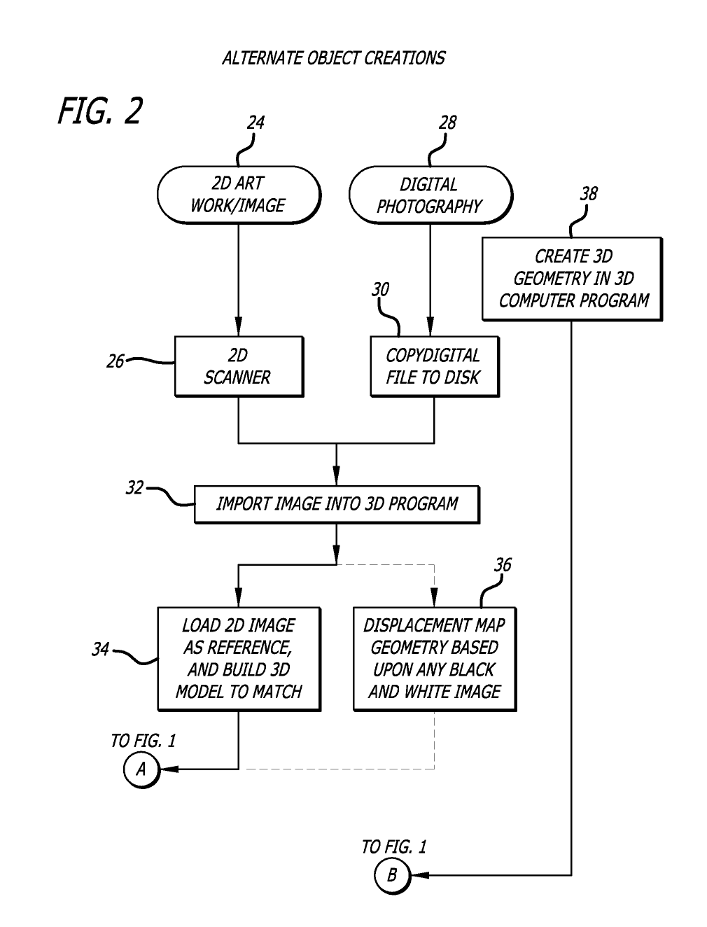

Alternatively, as is illustrated in FIG. 2, the scan file of 3D data points can be generated in step 24 from two dimensional (2D) artwork or a two dimensional image that exists on a two dimensional surface, such as from paintings, drawings, or other printed material, for example, such as by utilizing a two dimensional scanner 26 to digitize the two dimensional artwork or image in a digital two dimensional image file, for use in a 3D computer program. As another alternative, a file for a digital photograph generated using any digital camera or video device can be used, in step 28, and can be copied or transferred from the source device to a computer storage device in step 30 for use in a 3D computer program. The digital two dimensional image file or file for a digital photograph can be imported into a 3D computer program to create a file of 3D data points having a 3D geometry in step 32. How the 2D image is to be used to create a 3D geometry in the 3D computer program will determine what method would be required to import it into the 3D computer program. Although there are numerous ways to use 2D images in 3D computer programs to create a 3D image file of 3D data points having a 3D geometry, a presently preferred method is active building 3D geometry from a 2D reference image, shown in step 34, by manually assigning depth or height of data points of the 2D image to produce a desired 3D image. This method requires loading the 2D image as a “reference” upon which the 3D geometry can be built. The key to building the 3D geometry is to import the 2D image onto a card or image plane as a background template, and then construct the geometry in front of it to match. The more angles of the 2D image that are available for reference, the easier the 3D geometry build will be. While it is possible to build the 3D geometry from just one 2D image, this will make the 3D geometry build more difficult.

Alternatively, a step of displacement mapping 36 of the data points of the 2D image to produce a desired 3D image may be used, by displacing assigned depth or height data points over a surface of the 2D image according to values determined from apparent texture at each point on the surface of the 2D image, to give the surface of the 2D image a sense of depth and detail. Any grayscale or color image can be used to produce a displacement map, and the source of the displacement image can come from any part of a 2D image, such as color channels (red, green, blue), luminance or saturation, for example. As illustrated in step 38, alternatively a file of 3D data points can be created in a 3D computer program, or can be imported from a 3D file that was created somewhere else.

After the 3D geometry is created, as is indicated in step 40, the 3D geometry can be further edited to add, modify, scale, translate, rotate, remove or otherwise change 3D data points to create a 3D model. As is shown in step 44, one optional treatment of the 3D geometry involves inverting the 3D geometry derived from the 3D master object, as a basis for directly creating a negative mold to cast the final object in chocolate, candy, butter or other food material, for example. The term 3D master object as used herein refers to the object created on a 3D printer that is a physical manifestation of a real world object or image that was digitized using either a 3D scanner or other digitizing process. This object would in turn be used to cast an intermediate mold of silicone or used itself as an intermediate mold. To do this the 3D geometry used to create the master object must be inverted to create a “negative” version of the original source object. Since there would be no intermediate step to create a negative mold before the chocolate, candy or butter would be poured, the master object printed from the 3D printer must be negative so the resulting chocolate, candy or butter cast will be a duplicate of the original.

As is shown in step 42, the 3D geometry file is typically converted to a file format that is compatible for used in a 3D printer, such as the .STL file format, since most 3D printers support the .STL file format, although this step is only necessary if the original file was converted to a format other than .STL. As is illustrated in step 46, 3D printers are capable of printing objects using several different types of material. This material can range from ridged clear or opaque plastic to rubber-like substances, for example. Some of these materials can be FDA compliant/food safe, which means food can safely come in contact with them.

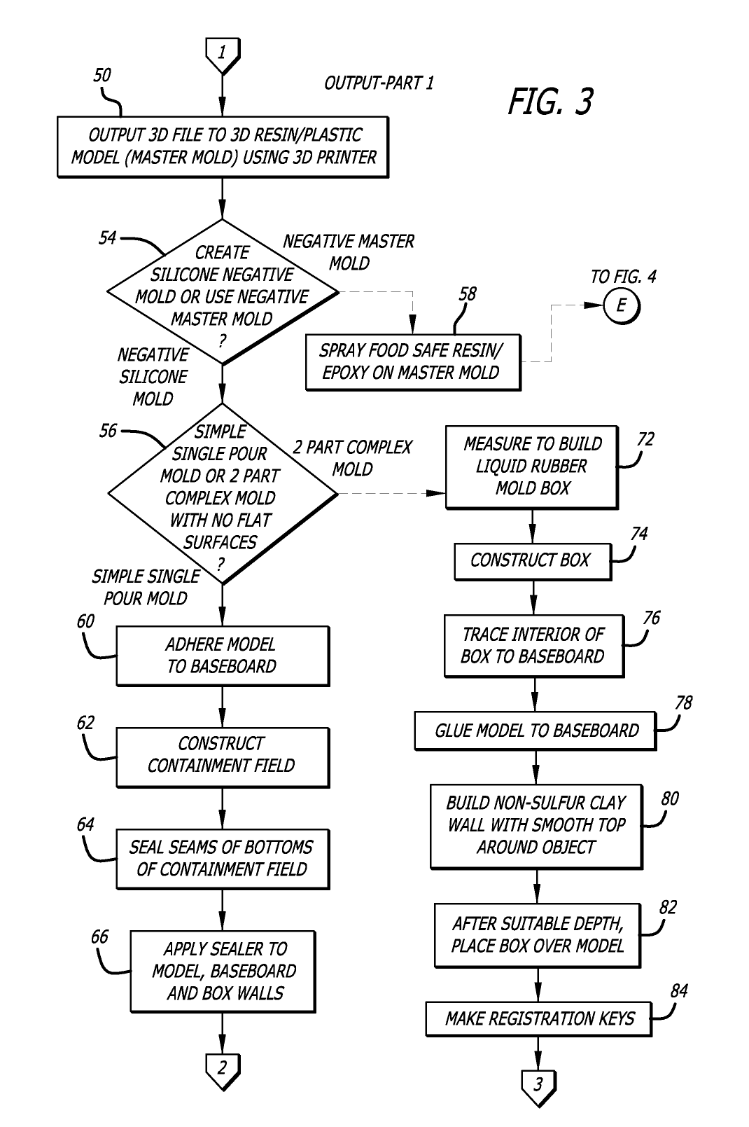

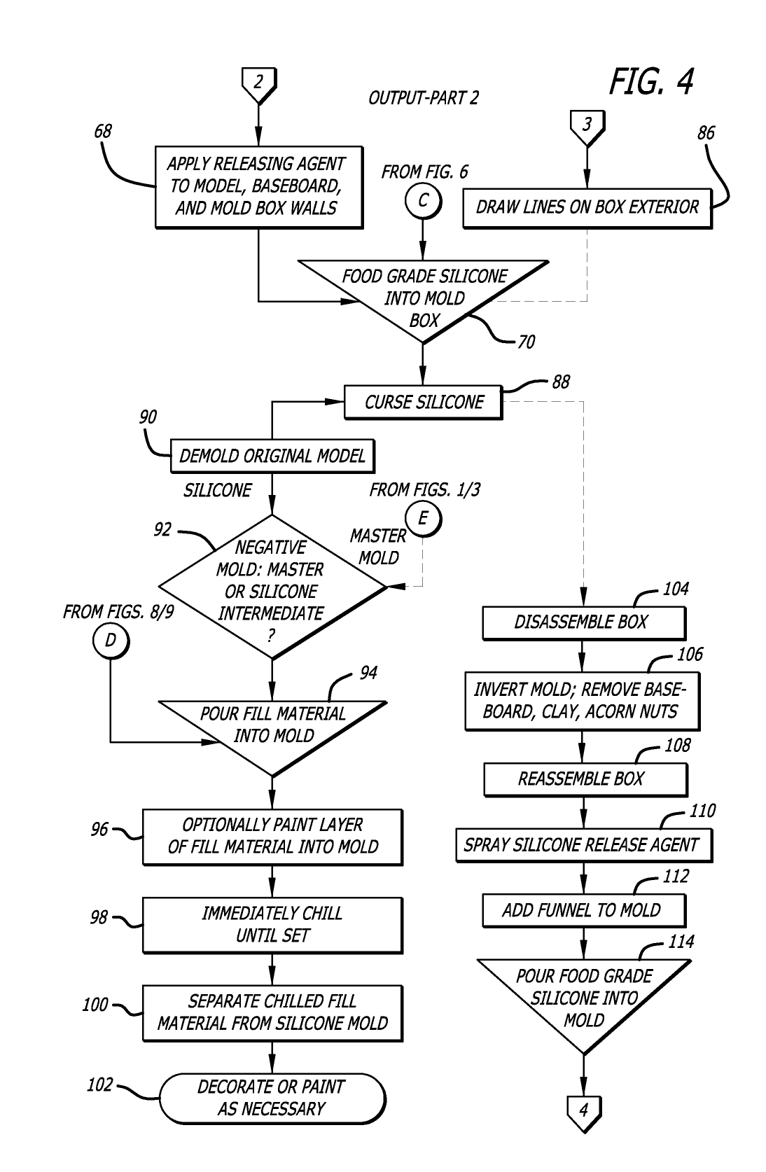

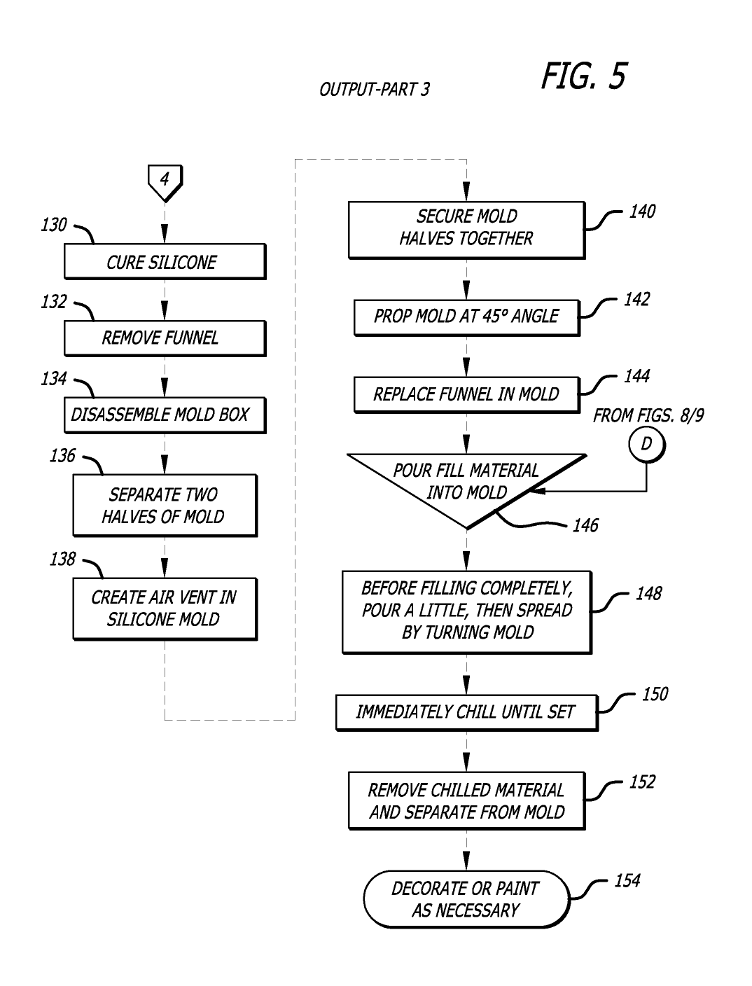

Once the 3D object is created or re-created and then converted to a compatible format by 3D printers (usually .STL), it is then printed using a 3D printer. 3D printing is a form of additive manufacturing technology where a three dimensional object is created by successive layers of material, which can be food safe/FDA compliant material or not food safe/FDA compliant material. The maximum size of an object that can be printed by a 3D printer is currently about 10-15 inches, so that if it is desired to form a larger object by a 3D printer, the larger object can be printed in small component pieces, which can be assembled to form the larger object. If the material that is chosen for 3D printing is not food safe/FDA compliant, then the 3D file can be output to produce a 3D resin or plastic model, or master mold, using a 3D printer in step 50 shown in FIG. 3, for use in creation of an initial non-food safe/FDA compliant negative mold. If the master object is used as an intermediate step negative mold, using food safe/FDA compliant material, then the 3D file can be output to produce a 3D resin or plastic model, or master mold, using a 3D printer, after which one can skip forward directly to step 92 shown in FIG. 4 for pouring the chocolate, candy, or butter into the mold.

Once the 3D file has been output to produce a 3D resin or plastic model, or master mold, using a 3D printer in step 50, the 3D resin or plastic model, or master mold can be used to create a silicone negative mold or can be used as a negative master mold. Referring to step 54, if the 3D geometry was not inverted, then an intermediate silicone mold must be produced, as indicated in step 56. This is also a required step if non-food safe/FDA compliant 3D printing material was used. Otherwise, if the geometry was inverted, then it can be used to create an intermediate negative mold indicated in step 58.

Referring to step 56, a silicone negative mold can be created as a simple single pour mold, or as a two-part (or multi-part) complex mold, with no flat surfaces. The complexity of the cast to be made in silicone will determine whether a single mold or a two-part mold technique would be necessary. If the object to be cast is not too ornate and has at least one flat surface that is proportionate to the rest of the object's surface, then a single mold can be used. Such a large flat surface area is indicated if the flat surface area can be used as a source in which to pour liquid to be cast, and is indicated if the object cast can be easily removed. In step 60, the model is adhered to a baseboard, such as to a baseboard of wood or acrylic with a hot glue gun, for example. As the first step in using the single pour method, the model is preferably glued to the baseboard, which will be the base of the containment field to contain the silicone. The flat side of the model should preferably be glued to the baseboard. Glue serves the dual purpose of keeping the model from sliding around during the silicone casting process, and to preventing any silicone from seeping below the model.

Referring to step 62, a containment field is constructed, typically using “L” shaped boards and C clamps, for example. The containment field can be built out of aluminum, acrylic, wood, or melamine, for example, and is typically built in four pieces, each one having an “L” shape, which gives the C clamps a place to clamp in order to connect the sides of the containment field together, and allows the containment field size to be adjustable. Alternatively, the top and bottom of each side of the containment field can optionally be built with a tongue and groove to make them stackable, and create a higher barrier. Referring to step 64, all seams of the bottoms of the containment field walls are preferably sealed, typically using a hot glue gun, modeling clay, caulk or the like. Sealing the bottom and intersections will prevent any silicone from seeping out of the containment field. As is indicated in step 66, if necessary, the model is also preferably sealed with a sealing agent. The sealing agent is applied to the model, baseboard, and mold box walls, and is useful to seal porous surfaces and to help the silicone release from the model and containment field. In step 68, a releasing agent is applied to the model, baseboard, and containment or mold box walls, such as by spraying the releasing agent, to prevent the silicone from sticking when the silicone is due to be removed, in order to complete the formation of the simple, single pour containment or mold box.

In step 70, after a food grade silicone is prepared, as will be further described herein below, the food grade silicone is poured into the mold box from step 68, or into the containment field from step 86 described hereinbelow, depending upon whether a simple mold or two-part (or multi-part) complex mold is prepared. The silicone is cured by allowing the silicone to set overnight, or using heat or an accelerator to shorten the curing time. While silicone generally takes approximately 24 hours to cure without the application or heat or an accelerator, addition of an accelerator to the silicone mixture typically added during the mixing process, described below, can allow curing to be completed within a few hours, and although heat can also shorten the curing time, typically curing is shortened less than by use of an accelerator.

Referring to step 72, for creation of a complex mold with two or more parts, as the first step in building a two-part (or multiple part) mold for the complex cast, measurements of the model are taken to determine the ultimate size of the containment box or mold box for containing liquid rubber or silicone. As is indicated in step 74, a containment box or mold box is constructed, such as from melamine, wood, or acrylic box, for example. When the box is constructed, a one inch (2.54 cm) clearance around the model is preferably maintained, to both improve stability of the mold, and help prevent any leakage during the casting process. In step 76, the interior of the box is traced onto a baseboard, prior to completing the assembly of the containment box, by placing the four walls onto the baseboard, and then tracing the inside of the walls onto the baseboard. Then in step 78, the bottom or flat side of the model is preferably glued to the baseboard, such as by hot glue, for example, and is placed on the bottom piece of the constructed box in the center of the traced area.

In step 80, a wall with a smoothed top is preferably built up around the object using non-sulfur based clay. The purpose of using clay is to create a temporary placeholder for about half of the mold. This placeholder will give the silicone a place to go to create the first half of the mold. The clay fills in any gaps around the model so that silicone doesn't leak through. Preferably non-sulfur based clays should be used so as to not react with the silicone. In step 82, after a suitable depth of clay is achieved, the walls of the box are replaced back over the model and clay. In step 84, registration keys can be made, typically by placing small ‘acorn nuts’ or cap nuts, of the type having a domelike cap over an engaged screw or bolt, around the perimeter of the clay and partially imbedded in the clay. The acorn nuts are used to create points in one half of the mold that would allow the two halves of the mold to align and fit together with each other. In step 86, shown in FIG. 4, lines are drawn on the exterior of the box to indicate proper assembly of the box walls. Drawing lines on the exterior of the box allows reassembly of the box the same way it was built previously, and helps maintain proper alignment with model and clay.

Referring to step 58, if a non-food safe/FDA compliant 3D printing material was chosen, and the 3D master object created from this material was intended to be used as the intermediate negative mold, then a food safe resin, epoxy, or lacquer is preferably applied to the mold before the mold can come in contact with any food items. After the mold is thoroughly covered, with the food safe resin, epoxy, or lacquer, then chocolate, candy, butter or other food material suitable for casting can be poured into the mold.

Referring to step 90 in FIG. 4, once the silicone of the simple or complex mold box has cured, the original model is delicately removed from the mold. In the formation of a negative master or silicone intermediate mold in step 92, either a prepared silicone cast of the 3D master object, the 3D master object printed using food safe/FDA compliant material, or a 3D master object inverted using non-food safe/FDA compliant material that is sprayed with food safe resin, epoxy, or lacquer can be used as intermediate negative molds to receive poured chocolate, candy, or butter. In step 94, the silicone is now ready for use, and heated chocolate, candy, butter, or water or other food material suitable for casting is preferably slowly poured into the mold, so that the liquid can occupy all the details of the mold. Referring to step 96, a layer of chocolate can be painted into the mold using pastry brush. Especially with intricate molds, before pouring all the chocolate/candy into mold, a thin layer or paint can be painted in a thin layer using a pastry brush, and spread throughout all the details in mold, to help insure an even coat and minimize/eliminate any imperfections or bubbles. In step 98, the mold and cast food material are immediately cooled, such as by placing the mold and cast food material in a refrigerator until the food material hardens. All of the liquids except water will set or harden when cooled in a refrigerator, but if water is used, then the mold and cast food material should preferably be put in a freezer. Once the chocolate, candy, butter, or ice has cooled and hardened, the mold can be removed from the refrigerator or freezer, and can be separated from the silicone mold in step 100. In step 102, the hardened molded product can be decorated or painted as necessary.

Alternatively, for a complex mold, after curing of the silicone, the complex mold box can be disassembled in step 104. About half of the box should be filled with silicone, and the other half filled with clay. Then in step 106, the mold is inverted, and the baseboard clay and acorn nuts are removed. The mold box is then reassembled in step 108, using screws, and the mold box should preferably have about half the box filled with the cured silicone, and the other half open, exposing part of the model. In step 110, a silicone release spray is sprayed on all surfaces of the mold box and model, in order to prevent the new silicone from sticking to the old, cured silicone. Referring to step 112, a funnel is added to the model using a small piece of clay to facilitate pouring liquid chocolate, candy, butter or water into the mold once the mold box is completed. In step 114, the prepared mixture of food grade silicone is poured into the mold box, and allowed to cure in step 130, as in steps 70 and 88 described above. The plastic funnel is removed in step 132, and the mold box is disassembled in step 134, to reveal preferably two (or more) pieces of silicone sandwiched together. In step 136, the two halves of the mold are separated, and an air vent is created in the silicone mold in step 138, to prevent air from getting trapped inside the mold as the liquid food material is poured in casting the mold. A small hollow brass tube that is sharpened at the end can be used to create the hole, preferably in a non-critical part of the mold. This area will most likely need a touch up after the mold is completed.

As is indicated in step 140, the two (or more) parts of the mold are then secured together, such as with rubber bands, for example, and preferably with relatively wide rubber bands. When securing the halves, the rubber bands should preferably be tied both horizontally and vertically across the mold. If the mold is small, one can use a piece of thin wood as a support for both sides that is sandwiched between the silicone and the rubber bands, to prevent the mold from deforming. Referring to step 142, the mold is then propped up at approximately a 45-degree angle to aid in de-airing or degassing the liquid as it fills the mold cavity. This will help push unwanted air out of the mold, instead of building up to create air bubbles or pockets. In step 144, the funnel is replaced in the mold, and in step 146, heated chocolate, candy, butter, or water or other food material suitable for casting is preferably slowly poured into the mold, so that the liquid can occupy all the details of the mold. Referring to step 148, a layer of chocolate can be painted into the mold using pastry brush. Especially with intricate molds, before pouring all the chocolate/candy into mold, a thin layer or paint can be painted in a thin layer using a pastry brush, and spread throughout all the details in mold, to help insure an even coat and minimize/eliminate any imperfections or bubbles. In step 150, the mold and cast food material are immediately cooled, such as by placing the mold and cast food material in a refrigerator until the food material hardens. All of the liquids except water will set or harden when cooled in a refrigerator, but if water is used, then the mold and cast food material should preferably be put in a freezer. Once the chocolate, candy, butter, or ice has cooled and hardened, the mold can be removed from the refrigerator or freezer, and can be separated from the silicone mold in step 152. In step 154, the hardened molded product can be decorated or painted as necessary.

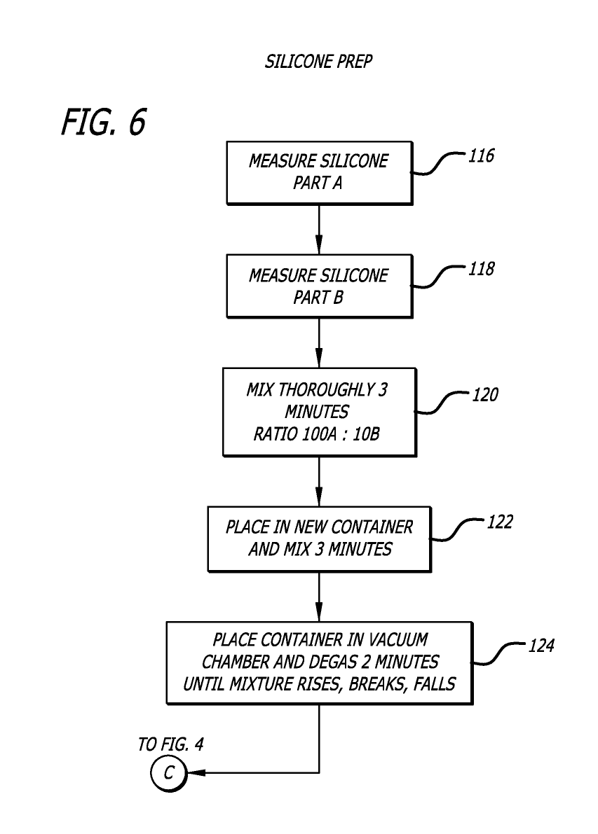

As is illustrated in FIG. 6, in preparation of the silicone mixture to be used in preparing the molds, since silicone is a two part mixed material, it is necessary to measure the two parts by weight, and a silicone part A is measured in step 116, and silicone part B is measured in step 118, typically using a gram scale, typically in a ratio of 100A to 10B, and the material is thoroughly mixed in a first container in step 120, typically for about 3 minutes. The initial mixture is placed in a second container and mixed again in step 122, typically for 3 minutes, to ensure that both parts mix thoroughly. In step 124, the second container is then placed in a vacuum chamber and degassed for about 2 minutes, until the mixture rises, breaks and falls. The vacuum process is used to remove any air that may be trapped in the mixture, since any trapped air remaining can cause problems with the final mold. The silicone mixture should then be ready to use in step 70, described above.

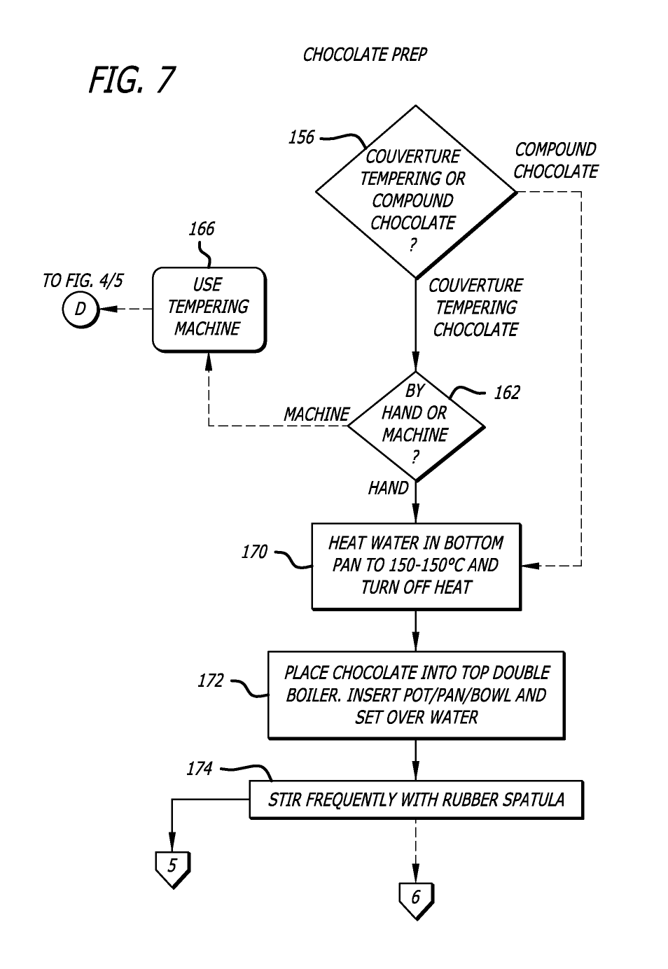

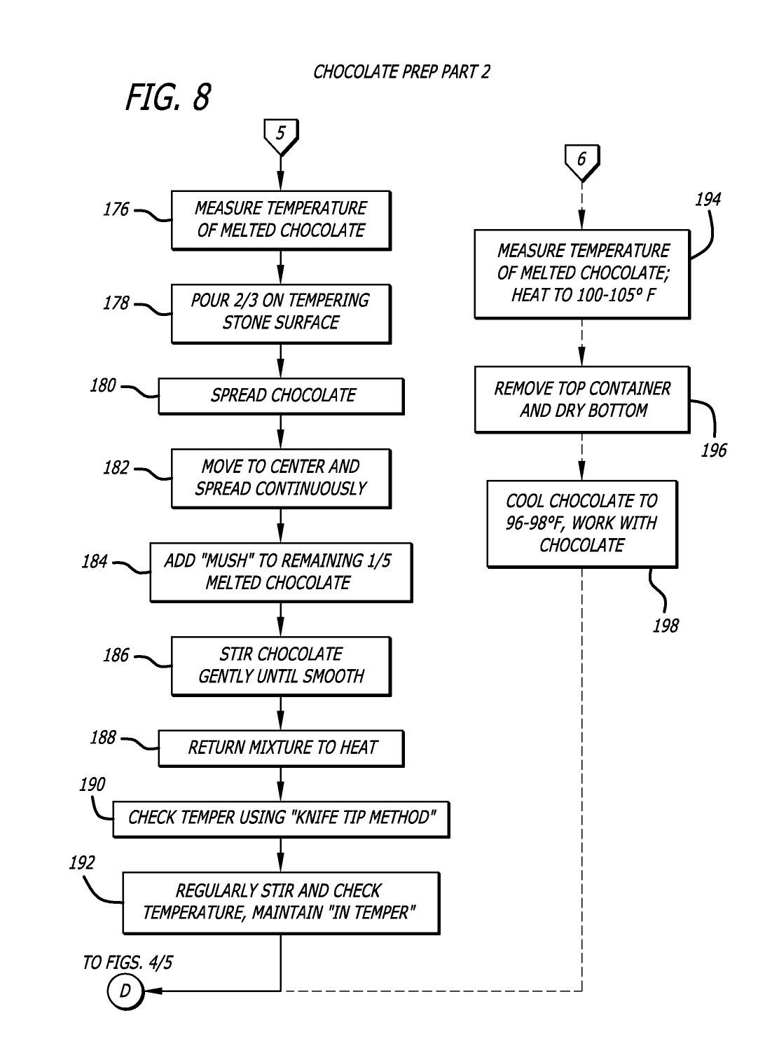

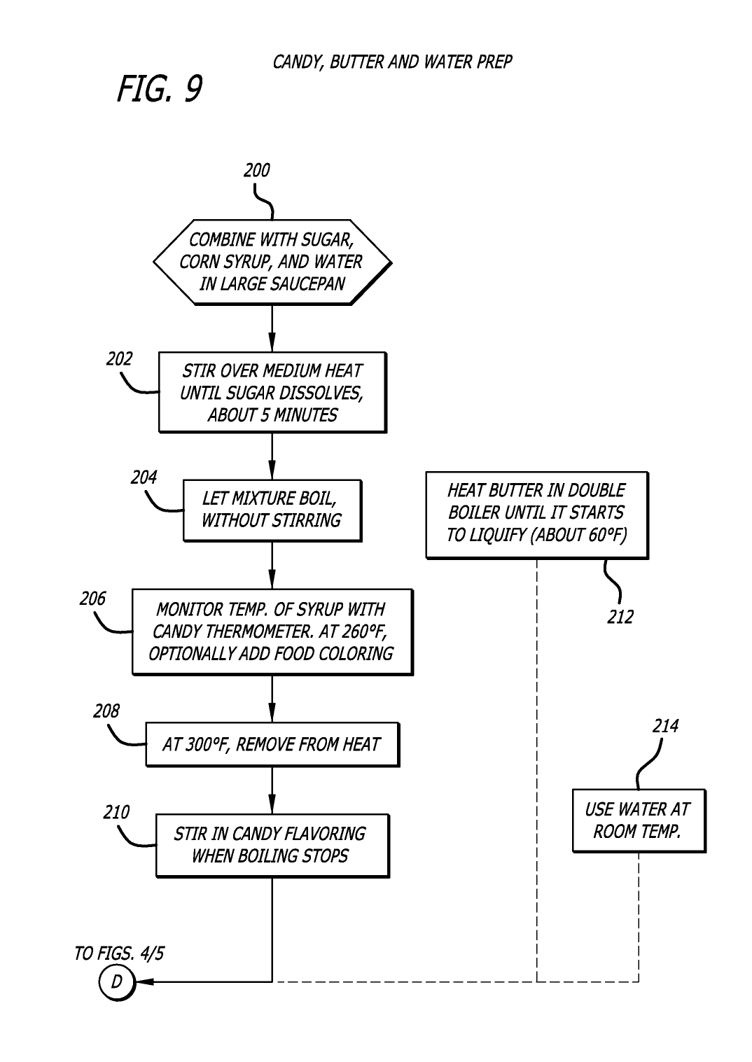

Referring to FIGS. 7 and 8, as indicated in step 156, couverture tempering chocolate or compound chocolate are preferably used in molding chocolate in the method of the invention. Couverture tempering chocolate, a type of chocolate that contains a very high percentage (at least 30%) of cocoa butter, generally requires tempering, such as by sequentially heating the chocolate to between 31° C. and 32° C. for milk chocolate, or between 32° C. and 33° C. for semi-sweet chocolate, and then cooling the chocolate to below its setting point, to prepare the chocolate to be melted for use in forming molded chocolate. Other similar methods of tempering the chocolate may also be suitable. Compound chocolate, which is typically is a less-expensive non-chocolate product replacement made from a combination of cocoa, vegetable fat, and sweeteners, doesn't require tempering and can simply be melted and poured into the molds. Temperatures for preparing chocolate differ per manufacturer, and the temperatures used in the method of the invention are based upon chocolate used from the company Chocoley of Georgia.

Referring to step 162, tempering of couverture chocolate is performed preferably manually beginning in step 170, or alternatively can be performed by a tempering machine in step 166, following a manufacturer's instructions to keep the chocolate in temper while pouring the chocolate in a mold, although for large-scale molding of chocolate, machine tempering can be preferred as being more efficient. For smaller batches, if manual tempering of couverture chocolate in step 170 is selected, the first step is to heat water in a bottom pan of a double boiler to about 130-150° F. (not to boiling), after which the heat is turned off. A double boiler is needed as chocolate has a low burning point, and needs to be melted gently. In step 172, the chocolate is then placed into the top portion of the double boiler, and set over the pan of water, and heated, with frequent stirring with a rubber spatula, in step 174. It is important that no moisture gets into the chocolate or the tempering process will fail.

Referring to step 176, once the chocolate is completely melted, a thermometer is used to measure the temperature of the chocolate, which should be heated to about 115° F. for milk chocolate, about 120° F. for dark chocolate, and about 110° F. for white chocolate. Referring to step 178, about ⅔ of the melted chocolate is then poured on a tempering stone surface, while keeping the other ⅓ at the same melting point temperature, without letting it harden. In step 180, using a pastry or bench scraper and offset spatula, the chocolate is spread, and then moved to the center, cleaning the scraper with the spatula, and spread continuously in step 182. This spreading and scraping process is continued until the chocolate cools to the following temperatures: dark chocolate about 82 degrees, milk chocolate about 80 degrees, and white chocolate about 78 degrees, which are a lower temperature than quick-tempering. The chocolate will lose its shine and form a thick paste with a dull matte finish. Working quickly so that the chocolate does not lump, this process can take anywhere from 2 to 10 minutes, depending on the amount of chocolate and the type, as well as the temperature of the kitchen. The professional term for this is “mush.” In step 184, the “mush” is added to the remaining ⅓ melted chocolate. Then in step 186, using a clean, dry rubber spatula, the chocolate is stirred gently, until smooth, being careful not to create air bubbles.

Referring to step 188, the mixture is then returned to heat, with constant stirring until the desired temperature is reached. For dark chocolate the temperature of the chocolate should reach about 90° F., for milk chocolate, the temperature of the chocolate should reach about 86° F. and for white chocolate the temperature of the chocolate should reach about 82° F. Referring to step 190, the temper should be tested before use of the chocolate, typically using the “knife tip method,” which is a simple method of checking if the chocolate is in temper, by applying a small quantity of chocolate to a piece of paper or to the point of a knife. If the chocolate has been correctly tempered, it will harden evenly and show a good gloss within five minutes. Or, alternatively, one can spread a thin layer on a scrap of parchment, wait five minutes, and then try to peel the chocolate from the paper. If this can be done, and the chocolate is not blotchy, the chocolate is tempered, and is ready to be used in molding chocolate objects. However, referring to step 192, while working with the chocolate, one should regularly stir the chocolate and check its temperature to keep it “in temper.” Ideal temperatures are 88-90° F. for dark chocolate, 86-88° F. for milk chocolate, and 82-84° F. for white chocolate. The chocolate will cool if not kept at a constant temperature, and gets thick and dull as is does. If chocolate cools too much and is still melted, one can reheat it multiple times back to a “temperate zone” of about 88 to 90° F. (dark), about 86 to 88° F. (milk), and about 82-84° F. (white). If the chocolate cools to the point of hardening, the tempering process must start again. The temperature of the chocolate should never be allowed to exceed 92° F. for dark chocolate, or 88° F. for milk and white chocolate, or the stable cocoa butter crystals will start to melt and the temper will be lost.

Alternatively, following step 174, once the chocolate is completely melted, one can heat the chocolate to between 100-105° F. in step 194, using a thermometer to monitor the temperature. Then in step 196, the top portion of the double boiler is removed, and the bottom of the top portion of the double boiler is dried. In step 198, the chocolate is allowed to cool and maintained at about 96-98° F. to work with the chocolate, and otherwise is ready to be used in molding chocolate objects.

For preparation of candy for use in molding of objects according to the method of the invention, in step 200, white sugar, corn syrup, and water (amounts vary based upon recipe) are combined in a mixture in a large saucepan. This is the first step if candy is the choice of food material to use instead of chocolate. Then in step 202, the mixture is stirred over medium heat until the sugar has dissolved, typically for about 5 minutes. In step 204, without stirring, the mixture is allowed to come to a boil. In step 206, a candy thermometer is used to monitor the temperature of the resulting syrup, and when the syrup reaches about 260 F, optional food coloring for color may be added (without stirring). In step 208, when the syrup reaches 300 F, it should be removed from the heat. In step 210, when the boiling stops, candy flavoring can be stirred into the syrup, and the candy is then otherwise is ready to be used in molding objects.

For preparation of butter for use in molding of objects according to the method of the invention, in step 212, using a double boiler, butter is heated until it just starts to liquefy (approx. 60 Deg). This is the only step to prepare butter for mold process, and then the butter is then otherwise is ready to be used in molding objects. Referring to step 214, water can be used at room temperature for use in molding of objects according to the method of the invention, in step 214, and this is the only step to prepare water for the mold process (i.e., to make ice sculptures).

While the method of the invention has been described above as useful for molding chocolate, candy, butter, water as ice, or other edible or food materials in three dimensional shapes from 3D or 2D images, it should be readily apparent that the method of the invention can alternatively be applied to other types of non-food or inedible materials that are suitable for casting as well, such as soap or wax, for example. It should also be readily apparent that the method of the invention can similarly alternatively be applied to directly produce chocolate, candy, butter, water as ice, or other edible or food materials in three dimensional shapes by a 3D printer from 3D or 2D images, with a suitable 3D printer and suitable food materials, bypassing an intermediate mold making process. It will be apparent from the foregoing that while particular forms of the invention have been illustrated and described, various modifications can be made without departing from the spirit and scope of the invention.

I claim:

1. A method for molding a composition from a three-dimensional image comprising:
converting a geometry of the three-dimensional image to a format that is compatible with a three-dimensional printer;
printing the three-dimensional image to a three-dimensional mold from a printing material using the three-dimensional printer;
pouring a fill material into the three-dimensional mold;
allowing the fill material to set in the three-dimensional mold; and
separating the fill material from the three-dimensional mold.

2. The method of claim 1, further comprising the step of adjusting a geometry of the three-dimensional image.

3. The method of claim 2, wherein the step of adjusting a geometry of the three-dimensional image comprises inverting the geometry of the three-dimensional image.

4. The method of claim 1, wherein the three-dimensional image is created with a computer program.

5. The method of claim 1, wherein the three-dimensional image is derived from a three-dimensional object and further comprising:
scanning the three-dimensional object with a three-dimensional scanner to form a scan of the three-dimensional object, the scan comprising a three-dimensional image; and
importing the scan into a three-dimensional program to view the three dimensional image produced by the scan.

6. The method of claim 5, wherein the scanner is a noncontact scanner.

7. The method of claim 5, wherein the scanner is a single pass scanner.

8. The method of claim 5, wherein the scanner is a multi-pass scanner and further comprising combining a plurality of scans of the three-dimensional object into a single composite three-dimensional image.

9. The method of claim 1, wherein the three-dimensional image is derived from a two-dimensional image and further comprising importing a two-dimensional image into a three-dimensional program.

10. The method of claim 9, further comprising building three dimensional geometry using the two-dimensional image as a reference to form the three-dimensional image.

11. The method of claim 9, further comprising displacement mapping data points of the two-dimensional image to form the three-dimensional image.

12. The method of claim 1, wherein the printing material is food safe.

13. The method of claim 1, wherein the printing material is non-food safe.

14. A method for molding chocolate, candy or other food materials into a molded, edible product in a shape based upon one or more three dimensional images of an original object that is desired to be replicated, comprising:
forming a set of three dimensional image data points describing a shape of a three dimensional object for optically imaging the three dimensional object;
forming a printed three dimensional object from said set of three dimensional image data points for forming a food safe mold; and
forming a three dimensional food object from said food safe mold.

15. The method of claim 14, wherein said step of forming a set of three dimensional image data points comprises forming a set of three dimensional image data points by at least one scan of the three dimensional object by a three dimensional scanner.

16. The method of claim 14, wherein said step of forming a set of three dimensional image data points comprises generating said set of three dimensional image data points from a set of two dimensional image data points describing a shape of a two dimensional image.

17. The method of claim 16, further comprising the step of converting said set of two dimensional image data points to the set of three dimensional image data points describing a shape of the three dimensional object for optically imaging the three dimensional object.

18. The method of claim 16, further comprising the step of displacement mapping of said set of two dimensional image data points to produce said set of three dimensional image data points.

19. The method of claim 14, further comprising the step of adjusting said set of three dimensional image data points.

20. The method of claim 19, wherein said step of adjusting said set of three dimensional image data points comprises inverting said set of three dimensional image data points for directly creating a negative mold.
